(19) United States
(12) Patent Application Publication
(10) Pub. No.: US 2006/0037186 A1
(43) Pub. Date: Feb. 23, 2006

(54) Method of manufacturing a tamper-resistant marker

(76) Inventor: Albert A. Burlando, Flanders, NJ (US)

Correspondence Address: PITNEY HARDIN LLP, 7 TIMES SQUARE, NEW YORK, NY, 10036-7311, US

(21) Appl. No.: 11/144,099

(22) Filed: Jun. 3, 2005

Related U.S. Application Data
(62) Division of application No. 10/923,971, filed on Aug. 23, 2004.

(51) Int. Cl. B23P 17/00

(52) U.S. Cl. 29/527.4; 29/458; 29/460; 29/527.1; 29/527.2

(57) ABSTRACT

A tamper-resistant marker includes a blank of metal sheet material in the form of a plane having a perimeter and two faces. A flange extends about the perimeter in a direction substantially perpendicular to the faces. One face of the metal blank has a rim raised in a direction opposite to that of the flange and forming a depression on the face. A label bearing a message to be posted using the marker is disposed in the depression and covered with a coating of polyurethane forming a dome over the label.

### CROSS REFERENCE TO RELATED APPLICATION

This is a divisional application based on U.S. patent application Ser. No. 10/923,971, filed Aug. 23, 2004.

### BACKGROUND OF THE INVENTION

1. Field of the Invention

The present invention relates to the marking of storm drains to alert members of the public to the dangers in dumping detrimental materials into waterways. More specifically, the invention relates to the manufacture of a tamper-resistant marker for this purpose.

2. Description of the Prior Art

The U.S. Environmental Protection Agency (EPA) has directed the states to develop programs to educate the public about the dangers to the environment when materials that are harmful to the health and safety of living organisms are dumped into streets and driveways, eventually to be washed to storm drains to enter rivers, streams, and other waterways and, possibly, our drinking water system.

The education program includes the marking of storm drains which lead from roadways and ultimately to waterways. Currently, several methods are used to carry out this marking.

Firstly, stencils have been commonly used to apply a warning message to the surface of concrete or asphalt near the storm drain. However, the paints typically used weather poorly and have to be redone every few years. The spray painting itself is time consuming, and cannot be done in wet or cold weather, or in windy conditions. Moreover, the paint vapors are potentially harmful to the user. The resulting prints are messy, and leave a message less clear than desirable.

Alternatively, ceramic tile markers, which have been screen-printed with an appropriate message and glazed, may be applied with adhesives and cemented in place. Ceramic tile markers, however, are easy to crack in use and are expensive. Flat cast or metal markers have also been used in the past. These have good life expectancy, but are expensive to manufacture and difficult to read. Because of their flat back, they often fail to adhere to the adhesives.

Finally, plastic domed markers are most often used to identify storm drains. They are made of a base material, such as vinyl or polycarbonate, screen-printed with an appropriate message, and die-cut into shape. The resulting blank is covered with a polyurethane coating having ultraviolet (UV) inhibitors to protect against damage caused by exposure to sunlight. This heavy, syrup-like coating flows to the edge of the blank and hardens. The resulting product has graphics under a clear plastic dome that thins near the edges. Adhesives, like liquid nails, may be used to apply the markers to various surfaces.

There are several problems associated with these plastic domed markers. Firstly, exposure to direct sunlight causes embrittlement in plastics. Secondly, diurnal temperature variations often cause the adhesive to fail on the undersurface of the marker because the flat vinyl surface is smooth and offers little bond to the adhesive. Finally, colorful, domed plastic markers are attractive and easily pried from the surfaces to which they are attached by vandals and other who like to collect them. A penknife or small screwdriver is all that is required for this purpose, as the plastic domed markers are flexible and can readily be peeled from the surface to which they are applied once an edge is exposed.

The present invention is directed toward these shortcomings of the prior art and provides a tamper-resistant marker which cannot be as readily removed from a surface as those of the prior art.

### SUMMARY OF THE INVENTION

Accordingly, the present invention is a tamper-resistant marker and a method of manufacturing the same. The marker comprises a blank of metal sheet material. The blank is substantially planar and has a perimeter. Extending about the perimeter in a direction perpendicular to the faces of the blank is a flange. The blank also has a raised rim, the rim being raised in a direction opposite to that of the flange. The raised rim encloses a depression on one of the two faces of the blank.

A label bearing some message or indicia to be posted on the marker is disposed in the depression. Finally, a coating of polyurethane forms a dome over the label in the depression.

As will be discussed below, the marker is mounted on a surface by cutting a groove thereinto having the shape of the flange extending around the perimeter of the blank. The flange resides in the groove below the level of the surface when mounted, making it difficult for a vandal to remove the marker.

The present invention also provides a method for manufacturing the marker. The method includes the steps of providing a blank of sheet metal, the blank having two faces and a perimeter, and of embossing a raised rim into one face of the blank to define a depression thereon.

The invention further includes the steps of forming a flange about the perimeter in a direction opposite to that of the raised rim, and of placing a label bearing some message or indicia into the depression.

Finally, the invention includes the steps of dispensing polyurethane over the label to cover the label and to form a dome of polyurethane thereover, and of curing the polyurethane.

The present invention will now be described in more complete detail with frequent reference being made to the figures identified below.

### BRIEF DESCRIPTION OF THE DRAWINGS

FIG. 1 is a plan view of a blank used to make the marker of the present invention;

FIG. 2 is a cross-sectional view of the blank taken as indicated in FIG. 1;

FIG. 3 is a view similar to that of FIG. 3 of the blank provided with a mounting flange;

FIG. 4 is a cross-sectional view of a first embodiment of the marker;

FIG. 5 is a cross-sectional view of a second embodiment of the marker;

FIG. 6 is a plan view of the marker;

FIG. 7 is a perspective view of a hole saw having a coaxial drill; and

FIG. 8 is a perspective view of an installed marker.

### DETAILED DESCRIPTION OF THE PREFERRED EMBODIMENT

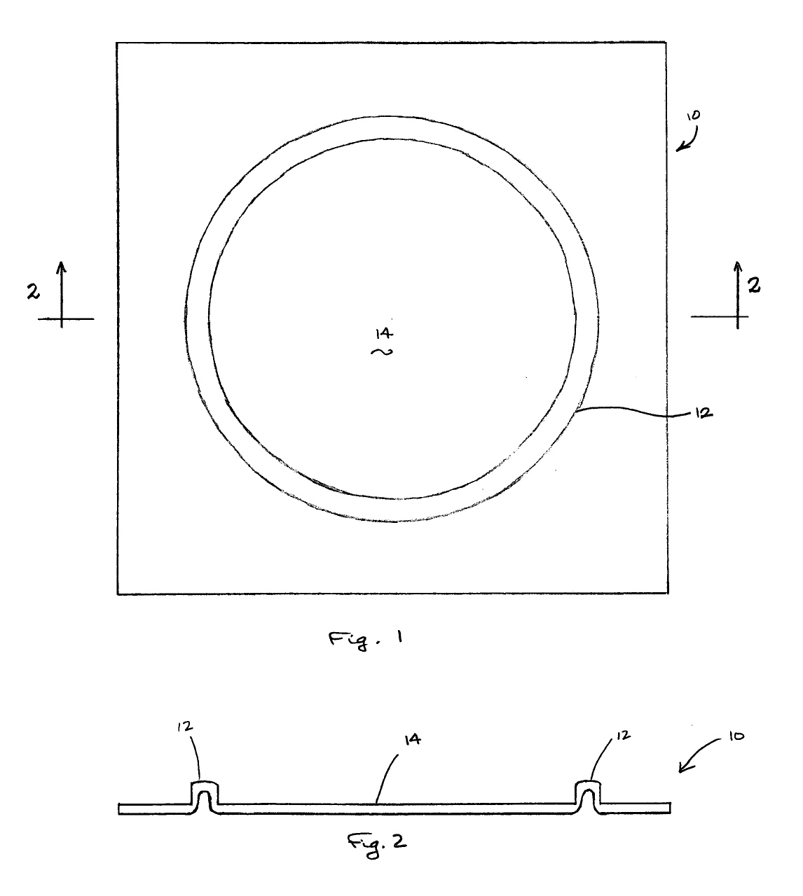

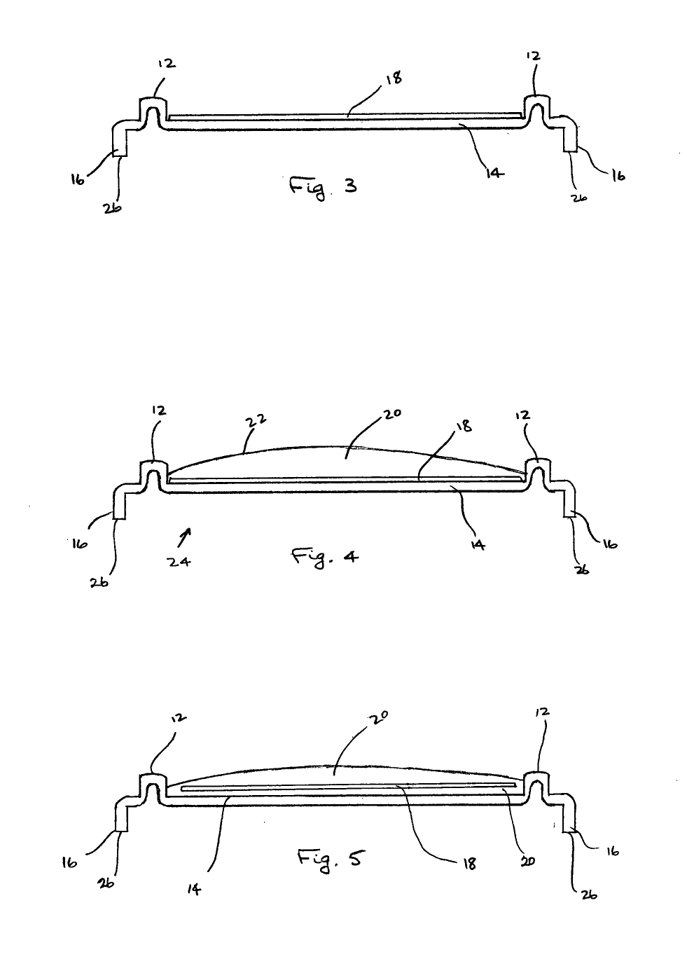

Turning now to these figures, FIG. 1 is a plan view of a blank 10 of the variety used in the practice of the present invention. The blank 10 is make of a metal, such as aluminum, brass or stainless steel, in heavy, 16-gauge (0.060-inch thick) sheets. Embossing dies are used to form a raised circular rim 12 on the blank 10, providing it with a circular depression 14, which is more clearly shown in the cross-sectional view provided in FIG. 2. A high tonnage power press, rated at 400 tons, is used to this purpose. The embossing adds strength to the metal material, often equivalent to doubling its thickness.

After embossing, the oversized plate is placed upon a blanking die that forms a dome, drawing the sides of the blank rearward to form as approximately 0.125-inch-deep dish-or cup-like shape just before it cuts the round blanks. The flange 16 formed in this operation is shown in FIG. 3.

The shaped blanks, which may, for example, be 4.0-inch-diameter disks, are then deburred by sanding the cut edges or tumbling the disks in an abrasive medium.

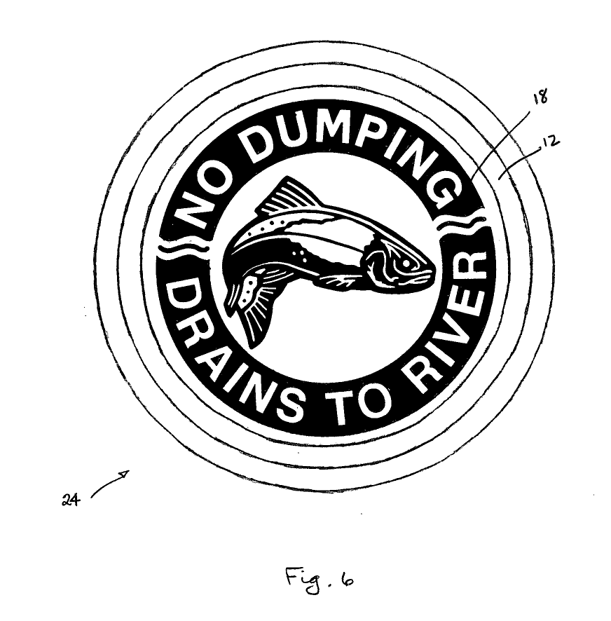

After cleaning, a label 18 is placed into depression 14 and held therein by an adhesive. Finally, a polyurethane 20 having ultraviolet (UV) inhibitors is dispensed into the depression 14 over label 18, filling the space over the label 18 within the circular rim 12, which acts as a dam allowing a greater thickness of polyurethane, having greater protection against ultraviolet radiation, to form a dome 22 over the label 18. The polyurethane 20 is cured and the marker 24 thereby obtained, as shown in cross section in FIG. 4, is ready for use.

Alternatively, label 18 may be encapsulated within polyurethane 20 instead of being held within depression 14 with an adhesive. In this alternative embodiment, some polyurethane 20 is first dispensed into depression 14, then label 18 is placed over the polyurethane 20. Finally, additional polyurethane 20 is dispensed over the label 18. The polyurethane 20 is then cured and the marker 24 thereby obtained, as shown in cross section in FIG. 5, is ready for use.

Marker 24 is shown in a plan view in FIG. 6. Label 18, of course, is visible through dome 22 of polyurethane 20, which cannot be seen in the drawing.

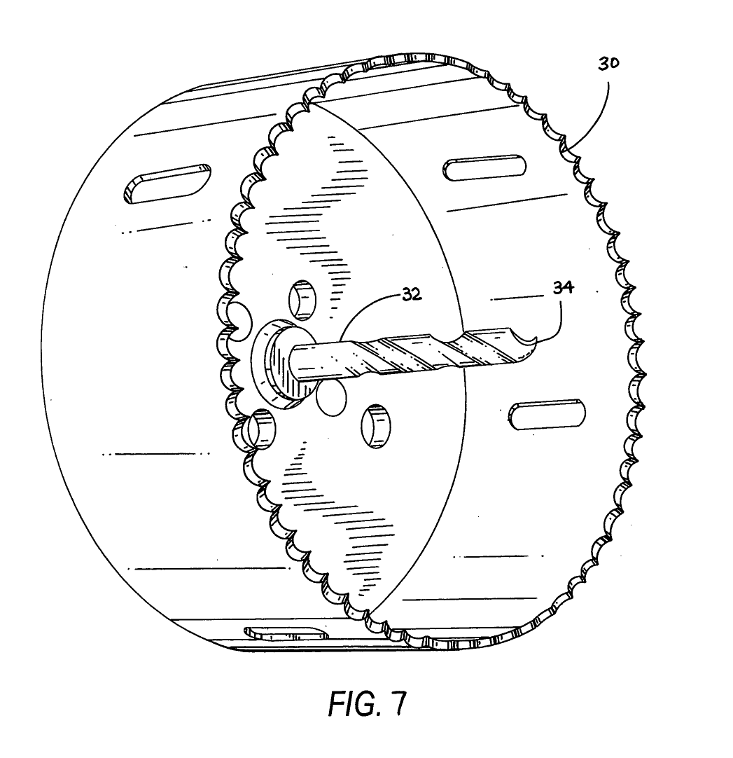

Marker 24 may be mounted onto a surface of concrete or other material in the following manner. The surface may be a flat or plane surface, and may also be the curved or flat surface of a utility pole of concrete, wood, or fiberglass. Referring to FIG. 7, a hole saw 30 having a diameter substantially equal to that of marker 24 may be used to make a shallow circular groove into the surface on which the marker 24 is to be mounted. For centering purposes, the hole saw 30 has a drill 32 with a carbide bit 34. Using a power tool, the hole saw 30 and carbide bit 34 can be used to drill a center hole, perhaps to a depth of 1.0 inch, in the center of a circular groove having a depth nominally in a range from 0.0625 to 0.125 inch into the concrete, asphalt or other surface where the marker 24 is to be mounted. The purpose of the circular groove is to accommodate the flange 16 on the marker 24.

Upon completion of the drilling process, dust and chips are blown or brushed out. An adhesive or epoxy is then applied to fill the area inside the circular groove. The marker 24 is then centered over the circular groove, lining up flange 16 therewith, and pressed down. As a consequence, the leading edge 26 or the flange 16 will be below the surface of the concrete asphalt or other material, and the marker 24 will be embedded in the surface, presenting a much lower tripping hazard than mounting by other mounting methods.

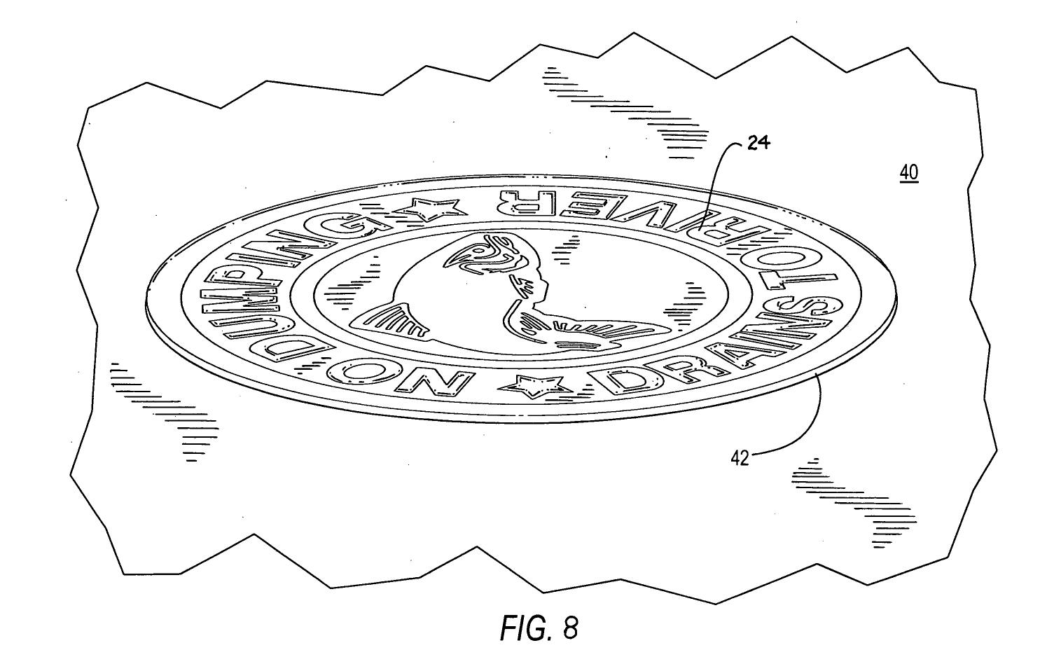

FIG. 8 is a perspective view of marker 24 installed on a surface 40 of concrete, asphalt or the like. Little adhesive or epoxy 42 may be seen around the perimeter of the marker 24. Because the flange 16 of marker 24 is within a circular groove in surface 40, an implement, such as a screw driver or penknife, cannot reach below leading edge 26 to pry the marker 24 away. When embedded into concrete or asphalt in this manner, a snow plow scraping the top surface thereof will not dislodge the marker 10 as its flange 16 is firmly mounted below the level of the surface 40.

Modifications to the above would be obvious to those of ordinary skill in the art, but would not bring the invention so modified beyond the scope of the appended claims.

What is claimed is:

1. A method of manufacturing a tamper-resistant marker, said method comprising the steps of:
providing a blank of sheet metal, said blank having two faces and a perimeter;
embossing a raised rim into one face of said blank to define a depression thereon;
forming a flange about said perimeter, said flange being in a direction opposite to that of said rim;
placing a label bearing some message or indicia into said depression;
dispensing polyurethane over said label to cover said label and to form a dome of polyurethane thereover, and
curing said polyurethane.

2. A method as claimed in claim 1, wherein said raised rim is circular in shape.

3. A method as claimed in claim 1, wherein said step of forming a flange further includes cutting said blank into a circular form.

4. A method as claimed in claim 1, wherein said step for forming a flange further includes forming a dome convexly in a direction opposite to that of said flange.

5. A method as claimed in claim 1 further comprising the step of deburring said flange.

6. A method as claimed in claim 1 further comprising the step of attaching said label to said depression with an adhesive.

7. A method as claimed in claim 1 further comprising the step of dispensing polyurethane into said depression before placing said label into said depression, so that said label may be encapsulated within said polyurethane

8. A method as claimed in claim 1, wherein said polyurethane includes ultraviolet inhibitors.
